(19) United States
(12) Patent Application Publication
(10) Pub. No.: US 2009/0109377 A1
(43) Pub. Date: Apr. 30, 2009

(54) OPTICAL ELEMENT, LIQUID CRYSTAL DEVICE, AND ELECTRONIC APPARATUS

(75) Inventors: Daisuke SAWAKI, Shiojiri (JP); Nobuhiko KENMOCHI, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/250,086

(22) Filed: Oct. 13, 2008

(30) Foreign Application Priority Data
Oct. 31, 2007 (JP) 2007-283169

(51) Int. Cl. G02F 1/1335; G02B 5/30

(52) U.S. Cl. 349/96; 359/486

(57) ABSTRACT

An optical element includes: a substrate; a grid formed on the substrate, the grid including a plurality of micro-wires and having a polarization-separation function; and a diffraction function layer formed above the grid. In the element, the diffraction function layer has at least two kinds of regions in a plane, and at least the two kinds of regions have different refractive indexes.

### BACKGROUND

The entire disclosure of Japanese Patent Application No. 2007-283169, filed Oct. 31, 2007 is expressly incorporated by reference herein.

1. Technical Field

The present invention relates to an optical element, a liquid crystal device and an electronic apparatus.

2. Related Art

A wire grid polarization element is known as one of optical elements having a polarization-separation function. The element has a number of conductive micro-wires arranged at a pitch smaller than the wavelength of light. The element also has the property of reflecting a component (TE) having a polarization axis parallel to the micro-wires and transmitting a component (TM) having a polarization axis perpendicular to the micro-wires among components of incident light.

When such wire grid polarization element is built in a semi-transmissive-reflective liquid crystal device, a wire grid polarization layer and a scattering layer are layered to a region corresponding to a reflective display region in one pixel region. The surface of the wire grid polarization layer has ridges and valleys to reflect and scatter light for achieving good display characteristics in a reflective display. This is because that the wire grid polarization layer having a flat surface shows extremely high luminance only in a specular reflection direction. This results in the luminance in a viewing direction being lowered, making difficult to see images. Refer to JP-T-2002-520677.

Such wire grid polarization layer is formed on an inner surface having ridges and valleys of a resin layer corresponding to a reflective display region. The wire grid polarization layer is formed by the following manner. First, as shown in FIGS. 19A and 19B, a metallic film 512 having light reflection property such as aluminum is formed on a concave-convex surface 511A of a resin film 511 by a vacuum film forming process. The metallic film 512 is formed with a thickness of about 0.1 μm and its surface has ridges and valleys (concave-convex shape) tracing the surface shape of the resin film 511. The pitch P between convex portions 512a is about 10 μm.

Then, a resist film 513 having photosensitivity is formed on the metallic film 512 showing such concave-convex shape. The resist film 513 is subjected to two-beam interference exposure and development so as to make a resist pattern. The metallic film 512 is dry-etched with the resist pattern. As a result, a number of micro-wires are formed, so that the wire grid polarization layer is formed.

Here, as shown in FIG. 19A, the height H of the asperity of the concave-convex surface 512A of the metallic film 512 is about 1 μm. When a resist is spin coated on the concave-convex surface 512A, as shown in FIG. 20, most of it is coated inside a concave portion 512b while the convex portion 512a is coated with a little of it. As a result, the resist film 513 cannot be formed with a uniform thickness. In this case, an exposure amount with respect to the resist film 513 differs from place by place (the convex portion 512a and the concave portion 512b). As a result, a resist pattern having a uniform shape cannot be achieved. That is, when the resist film 513 shown in FIG. 20 is exposed, no resist pattern is formed on the convex portion 512a, as shown in FIG. 21, because the resist film 513 is not coated on the convex portion 512a.

FIG. 22 shows the metallic film 512 having been etched with the resist pattern shown in FIG. 21 as a mask. As can be seen from FIG. 22, the metallic film 512 on the concave portion 511b of the resin film 511 is well etched whereas the metallic film 512 on the convex portion 611a is mostly removed, resulting in the concave-convex surface 511A of the resin film 511 appear. In this way, it is obvious that forming a wire grid polarization layer on the concave-convex surface 512A of the resin film 511 is difficult because of the problems in processes as described as above.

This structure also has a problem from a point of view of the performance of a liquid crystal device. As shown in FIGS. 19A and 19B, the height H of the asperity of the resin film 511 (metallic film 512) is about 1μm. This concave-convex shape causes variations in the thickness of a liquid crystal layer. Typically, the liquid crystal layer is designed with a thickness of about 5 μm. Thus, the height H means that the thickness of the liquid crystal layer varies by about 20 percent in a plane. This variation causes the deterioration of the contrast of images.

To cope with the problems above, it is conceivable that a wire grid polarization layer is provided on a substrate and a diffraction function layer achieves a function to scatter reflected light.

A conceivable structure is shown in FIGS. 23A, 23B, and 24. FIG. 24 is a sectional view of FIGS. 23A and 23B. As shown in FIG. 23A, a diffraction function layer 614 is disposed on a substrate 6. The diffraction function layer 614 is a structure having a larger period than the wavelength of visible light. On the surface of the diffraction function layer 614, a wire grid polarization layer 615 (nondiffracting structure) is disposed as shown in FIG. 23B. This structure can reduce the height g (difference in height) of a step 616 of the diffraction function layer 614 to about 0.1 μm as shown in FIG. 24. That is, the height, about 1 μm conventionally, can be reduced to about one tenth. This reduction drastically reduces the thickness variation produced in coating resist when the wire grid polarization layer 615 is formed. As a result, a resist pattern having a uniform thickness can be achieved. In addition, the thickness variation of a liquid crystal layer also can be reduced, enabling the lowering of contrast to be prevented.

The conceivable structure described above can drastically reduce the surface step (difference in height of the step 616) of the diffraction function layer 614 on which the wire grid polarization layer 615 is formed as compared to the conventional structure. However, in forming the wire grid polarization layer 615, a forming defect of the wire grid polarization layer 615 may occur because a resist pattern R is incompletely formed in the vicinity of the step 616.

FIG. 25 shows a resist spin-coated on the diffraction function layer 614 (difference in height of the step 616 is about 0.1 μm). The resist, a resist film 617, is subjected to two-beam interference exposure to achieve a resist pattern shown in FIG. 26. FIG. 26 is a sectional view showing a part of the resist film in FIG. 25 after the exposure. In FIG. 26, it looks that the resist pattern R is formed roughly on the entire surface of the diffraction function layer 614. However, incomplete formed portion occurs in the vicinity of the step 616 because the bottom of the resist film 617 is exposed with an insufficient exposure amount.

This incomplete formed portion may be due to an intensity distribution in a plane. The intensity distribution is produced by a phase modulation of exposure light due to the step shape of the resist surface. This conceivable structure reduces the difference in height as compared to the conventional one. However, incomplete formed portion may occur when a step is produced on the resist surface because the resist is not flatly coated without covering the step.

### SUMMARY

An advantage of the invention is to provide an optical element having a wire grid polarization layer easily manufactured and superior optical characteristics, a liquid crystal device having high functions and manufactured by simplified processes, and an electronic apparatus.

According to a first aspect of the invention, an optical element includes: a substrate; a grid formed on the substrate, the grid including a plurality of micro-wires and having a polarization-separation function; and a diffraction function layer formed above the grid. In the element, the diffraction function layer has at least two kinds of regions in a plane, and at least the two kinds of regions have different refractive indexes.

The optical element has the grid on the plane of the substrate. This structure can improve the uniformity of an exposure amount of a resist in the plane in processes to manufacture a wire grid. As a result, a wire grid having good optical characteristics (polarization separation property) can be reliably achieved.

In the invention, light is scattered by the diffraction function layer and polarized and separated by the grid. In addition, increasing the refractive index difference of the two kinds of regions of the diffraction function layer can enhance the intensity of first-order diffraction light, enabling the diffusion effect of light passing through the diffraction function layer to be improved.

In this way, the optical element can separate incident light into reflected light and transmitted light that have different polarization states, and diffuse the light in the emitting directions.

It is preferable that the regions be irregularly arranged in a direction of the plane.

This structure provides an irregular distribution having no regularity and no statistical bias to the two kinds of regions in the diffraction function layer. Therefore, incident light can be diffused in various directions. That is, the optical element can scatter incident light in a wider range.

It is preferable that a unit pattern in which the two regions are irregularly arranged in the plane direction be arranged in a plurality of numbers.

According to such structure, a photomask used for manufacturing the diffraction function layer can also employ a structure in which a mask pattern (resist pattern) corresponding to the unit pattern is repeatedly disposed, allowing the photomask to be easily made. As a result, the optical element is easily manufactured.

It is preferable that one unit pattern and another unit pattern adjacent to the one unit pattern be arranged in a different arrangement angle each other in the plane direction.

Accordingly, the bias of diffusion direction due to the repeated cycle of the unit pattern can be resolved.

It is preferable that the element further include a covering layer between the grid and the diffraction function layer and the covering layer be made of a dielectric material.

As a result, the adhesiveness between the diffraction function layer and grid can be improved by interposing the covering layer therebetween. In addition, the covering layer can form a sealed space between the micro-wires, allowing the optical characteristics of the wire grid polarization layer to be improved.

It is preferable that an antireflection film be formed on the diffraction function layer.

This structure can lower light reflected on the surface of the diffraction function layer. As a result, deterioration of contrast can be prevented since the light entering the surface of the diffraction function layer is not polarized and separated so that it becomes leak light that deteriorates contrast.

According to a second aspect of the invention, a liquid crystal device includes the optical element.

The invention can provide a liquid crystal device provided with the optical element having a superior light scattering function.

It is preferable that the liquid crystal device further include a liquid crystal layer between a pair of substrates, and the optical element be formed at a side adjacent to the liquid crystal layer of at least one of the pair of substrates.

The invention can provide a liquid crystal device having a built-in reflection polarization layer. Since the optical element has the grid on the plane of the substrate, the surface of the diffraction function layer disposed on the grid is flat. Thus, when the optical element is built inside a liquid crystal cell, the thickness of the liquid crystal layer is uniformed. As a result, improvement of images (contrast) can be expected. In addition, in rubbing treatment of an alignment film provided on the diffraction function layer, the uniformity in a plane also can be improved. As a result, improvement of images can be expected.

It is preferable that the liquid crystal device be a semi-transmissive reflective type liquid crystal device in which both a transmissive display and a reflective display are possible in a single pixel, and include the optical element as a reflection layer to perform a reflective display.

The invention can provide a semi-transmissive reflective liquid crystal device that can achieve a high contrast display both the transmissive display and the reflective display.

According to a third aspect of the invention, an electronic apparatus includes the liquid crystal device.

The invention can provide an electronic apparatus that has a display part or an optical modulation unit having high display quality and reliability.

According to a fourth aspect of the invention, an electronic apparatus includes the optical element.

The invention can provide an electronic apparatus superior in optical characteristics and reliability.

### BRIEF DESCRIPTION OF THE DRAWINGS

The invention will be described with reference to the accompanying drawings, wherein like numbers reference like elements.

FIGS. 1A and 1B are overall structural views of an optical element according to an embodiment of the invention.

FIG. 1A is a perspective view showing a rough structure of the optical element.

FIG. 1B is a perspective view showing a shape of micro-wires of a wire grid polarization layer.

FIG. 2 is a sectional view taken along the X-Z plane in FIG. 1A.

FIGS. 3A and 3C are explanatory views showing a function of a diffraction function layer.

FIG. 3B is an explanatory view showing a function of a grid.

FIGS. 4A and 4B are graphs showing reflected light characteristics of the optical element.

FIG. 4A shows the wavelength dependence of reflection coefficient.

FIG. 4B show the wavelength dependence of contrast.

FIG. 5 is a diagram showing an example of arranging unit patterns in the optical element.

FIG. 6 is a flowchart of a method for manufacturing the optical element.

FIGS. 7A to 7F are sectional views in the manufacturing steps of the optical element.

FIGS. 8A to 8C are sectional views in the manufacturing steps of the optical element succeeding FIGS. 7A to 7F.

FIGS. 9A and 9B are graphs showing relations between the thickness of an antireflection film and the reflected light intensity on the interface between a resist and the antireflection film when the resist is layered on the antireflection film.

FIG. 10 shows an example of the shapes of a first region and a second region of the diffraction function layer.

FIG. 11 shows an example of the shape of the minimum unit of the first and the second regions of the diffraction function layer.

FIG. 12 is an equivalent circuit diagram of a plurality of sub-pixel regions included in a liquid crystal device according to the invention.

FIGS. 13A and 13B are plane views illustrating one sub-pixel region of the liquid crystal device according to the invention.

FIG. 14 is a partial sectional view taken along the line B-B′ in FIG. 13A.

FIG. 15 is a schematic view showing a rough structure of a projector.

FIGS. 16A and 16B are graphs showing reflected light characteristics of the optical element.

FIG. 16A shows the wavelength dependence of light transmissivity.

FIG. 16B show the wavelength dependence of contrast.

FIG. 17 is a schematic view showing a modification of the projector.

FIG. 18 is a perspective view showing an example of an electronic apparatus according to the invention.

FIGS. 19A and 19B are perspective views of a metallic film in forming a conventional wire grid polarization layer.

FIG. 20 is a sectional view showing the coated condition of a resist on the conventional metallic film shown in FIGS. 19A and 19B.

FIG. 21 is a perspective view showing a state after the resist shown in FIG. 20 is exposed.

FIG. 22 is a perspective view showing a state after the metallic film is etched based on the resist shown in FIG. 20.

FIG. 23A is a perspective view of a conceivable optical element.

FIG. 23B is a perspective view showing the rough structure of a conceivable diffraction function layer.

FIG. 24 is a sectional view of the conceivable optical element taken along the X-Z plane in FIG. 23A.

FIG. 25 is a perspective view showing a state after a resist is coated on the diffraction structure shown in FIGS. 23A, 23B, and FIG. 24.

FIG. 26 is a sectional view showing a resist pattern after the resist shown in FIG. 25 is exposed.

### DESCRIPTION OF EXEMPLARY EMBODIMENTS

Embodiments of the invention will be described below with reference to the drawings. Note that scales of members in the drawings referred to hereinafter are adequately changed so that they can be recognized.

Optical Element

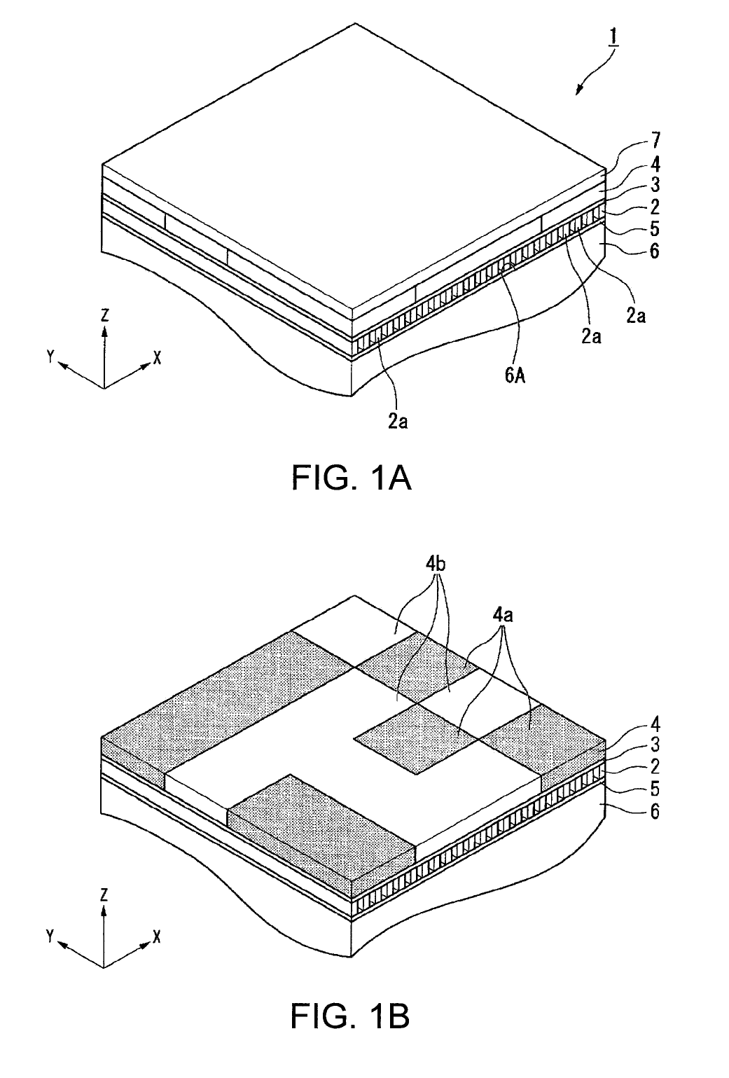

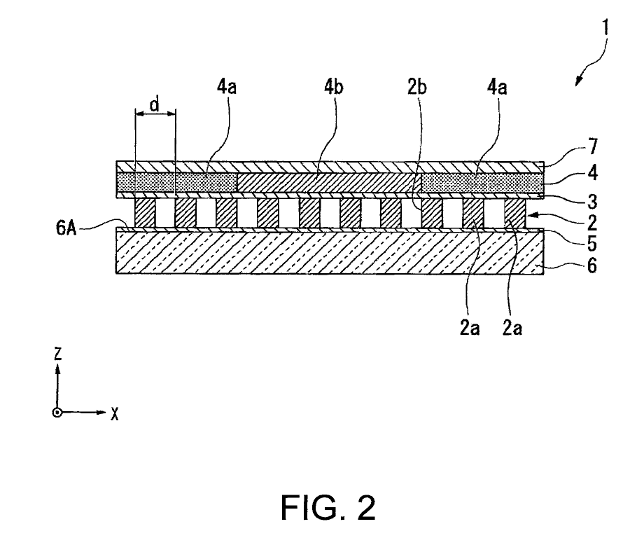

FIGS. 1A and 1B are perspective views schematically showing the structure of an optical element according to an embodiment of the invention. FIG. 2A is a sectional view of an optical element 1 taken along the X-Z plane in FIG. 1A. The optical element 1 includes a substrate 6, a wire grid polarization layer 2 disposed on the substrate 6, a diffraction function layer 4 disposed above the wire grid polarization layer 2 with a covering layer 3 interposed therebetween, an AR coat film 7, and a counter substrate (not shown).

FIG. 1B is a perspective view showing the arrangement of the diffraction function layer.

The substrate 6 is a transparent substrate such as glass, quartz, and plastic. As shown in FIG. 2, the wire grid polarization layer 2 is formed on one surface of the substrate 6.

The wire grid polarization layer 2 is composed of a plurality of micro-wires 2a made of aluminum in parallel with each other and forms a stripe pattern in plan view. A disposition pitch d of the micro-wires 2a is smaller than the wavelength t of incident light and may be set to 140 μm, for example. In the embodiment, the wire grid polarization layer 2 is formed on a surface 6A (specifically on an underlayer 5) having a flat surface of the substrate 6. Thus, the top surfaces of the micro-wires 2a each having the same shape show nearly a flat surface. Note that the number of the micro-wires 2a is shown smaller than that of actual micro-wires 2a in FIGS. 1A, 1B and 2 for the sake of convenience.

The underlayer 5 is formed on the substrate 6 so as to cover the surface of the substrate 6. The underlayer 5 is formed if needed. The underlayer 5 can be formed by a silicon oxide film or an aluminum oxide film, for example. The underlayer 5 prevents the substrate 6 from being damaged by etching when the micro-wires 2a are patterned by etching. The underlayer 115 also enhances the adhesive property of the micro-wires 2a with respect to the substrate 6. The wire grid polarization layer 2 is formed on the underlayer 5.

The covering layer 3 is formed on a surface of the wire grid polarization layer 2, the surface being opposite to the surface thereof facing the substrate 6, so as to cover the micro-wires 2a. With the covering layer 3, an opening 2b formed between the micro-wires 2a is sealed. As a result, a space surrounded with the substrate 6 (underlayer 5), a pair of micro-wires 2a adjacent one another and the covering layer 3 is sealed in a vacuum state. Here, the film thickness of the covering layer 3 is preferably thinner than that of the diffraction function layer 4, and may be about 0.3 μm to about 0.5 μm. The covering layer 3 is also preferably a thin film made of a material different from those of both the diffraction function layer 4 and the wire grid polarization layer 2. For example, a dielectric thin film such as silicon oxide (SiO₂) and silicon nitride (SiN) can be used.

With the covering layer 3, the adhesive property between the diffraction function layer 4 and the wire grid polarization layer 2 can be enhanced as well as a sealed space can be formed between the micro-wires 2a.

The diffraction function layer 4 is disposed above the wire grid polarization layer 2 with the covering layer 3 interposed therebetween. The diffraction function layer 4 includes a plurality of first regions 4a and a plurality of second regions 4b. The first regions 4a and the second regions 4b are two-dimensionally arranged in a plane manner. The material forming the first regions 4a has a refractive index different from that of the material forming the second regions 4b. In the embodiment, the refractive index of the first regions 4a is preferably higher than that of the second regions 4b. The difference between the refractive indexes is preferably large. Examples of the material for forming the first regions 4a include TiO₂, TaO₅, SiON, SiC, and Si₃N₄. The thickness of the diffraction function layer 4 is described later.

In the embodiment, the AR coat film 7 is formed on the surface (the top surface) of the diffraction function layer 4 as an antireflection treatment.

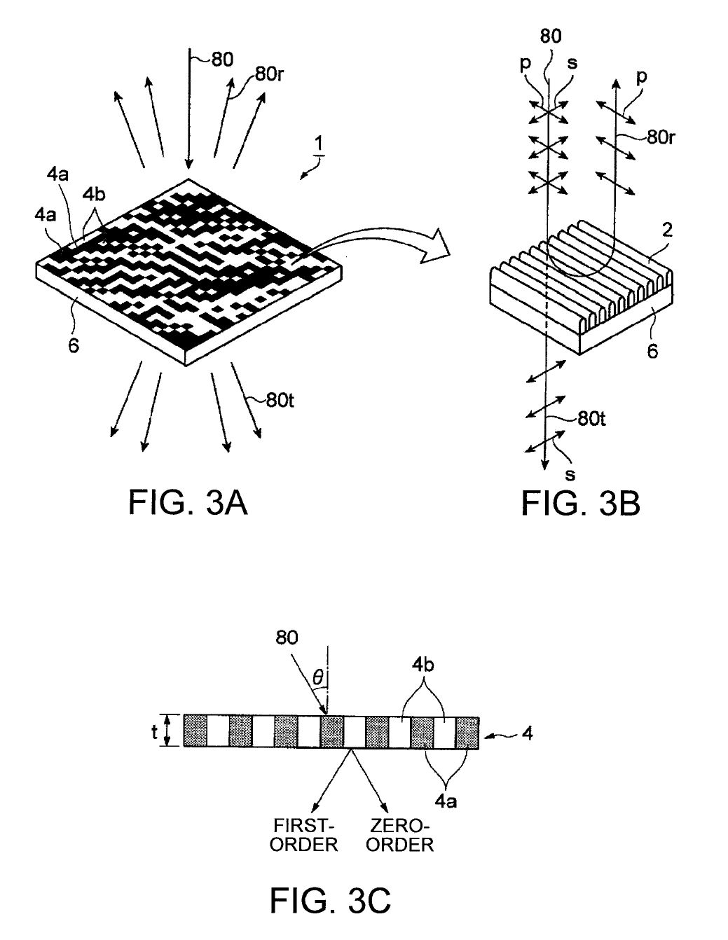

FIGS. 3A, 3B and 3C are schematic views for explaining the function of the optical element 1.

FIG. 3A is an explanatory view illustrating the function of a grid. FIGS. 3B and 3C are explanatory views illustrating the function of the diffraction function layer. FIG. 3B schematically shows the wire grid polarization layer 2. FIG. 3C schematically shows the diffraction function layer 4.

In the optical element 1 shown in FIG. 3A, black areas correspond to the first regions 4a and white areas correspond to the second regions 4b. The diffraction function layer 4 includes the first regions 4a and the second regions 4b that are distributed in a plural number in a plane manner. The distribution in the region diffracts an incident light 80 so as to be scattered in directions different from the incident direction as shown in FIG. 3A.

As shown in FIG. 3B, among components of incident light (the light 80 after passing through the diffraction function layer 4) to the wire grid polarization layer 2, a component p (TE) having a polarization axis parallel to the micro-wires 2a is reflected by the wire grid polarization layer 2, and a component s (TM) having a polarization axis perpendicular to the micro-wires 2a passes through the wire grid polarization layer 2. That is, the optical element 1 including the wire grid polarization layer 2 has a polarization-separation function and separates the incident light 80 into a reflected light 80r and a transmitted light 80t that are different in a polarization state. The reflected light 80r enters the diffraction function layer 4 again so as to be scattered in directions different from the entering direction.

More specifically, the diffraction function layer 4 can diffuse both the reflected light 80r reflected by the wire grid polarization layer 2 and the transmitted light 80t passing through the wire grid polarization layer 2. The diffusion characteristics of the reflected light 80r and the transmitted light 80t can be controlled as described later.

The diffusion effects of the reflected light 80r and the transmitted light 80t shown in FIG. 3A can be controlled by changing a thickness t of the diffraction function layer 4. In the embodiment, the optical element 1 is adapted to diffract the incident light 80 into first-order diffraction light as much as possible with the diffraction function layer 4 as shown in FIG. 3C. Here, the thickness t of the diffraction function layer 4 is presented by the following equation (1) when energy of first-order light shows the maximum

t=cos θ/(2·Δn) (1)

where λ is the wavelength of the incident light 80, θ is the incident angle, and Δn is the refractive index difference of diffraction grating (i.e., refractive index difference of the first region 4a and the second region 4b of the diffraction function layer 4.

For example, in a case where λ=0.5 μm, which is the wavelength of green to which the human eye has the highest sensitivity, the optimum thickness t of the diffraction function layer 4 is 1.76 μm where the incident angle θ of incident light is 45 degrees and the refractive index difference of diffraction grating Δn is 0.1.

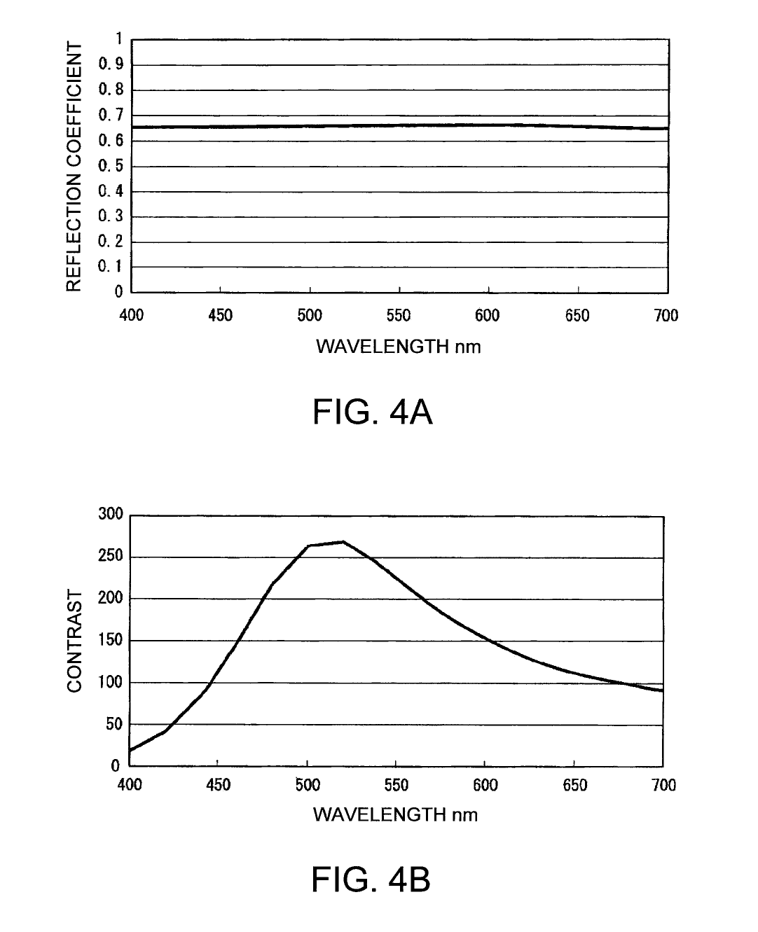

When the optical element 1 is applied to a reflection type device, reflected light characteristics are important. FIGS. 4A and 4B are graphs showing reflected light characteristics of the optical element 1. FIG. 4A shows the wavelength dependence of reflection coefficient. FIG. 4B shows the wavelength dependence of contrast. As shown in FIG. 4A, the reflection coefficient is not remarkably fluctuated in the wavelength range. On the other hand, contrast varies depending on wavelength. Higher contrast is not achieved in higher wavelength. As shown in FIG. 4B, contrast increases as wavelength increases. However, contrast becomes gradually lower from a certain wavelength.

As described above, the optical element 1 including the diffraction function layer 4 and the wire grid polarization layer 2 can diffuse the incident light 80 with the diffraction function layer 4 and the diffused light can be separated into the deflected light 80r and the transmitted light 80t in a different polarization state one another with the wire grid polarization layer 2. Specifically, the incident light diffused with the diffraction function layer 4 is separated as follows. A linearly polarized light (the transmitted light 80t) having a polarizing axis orthogonal to the direction in which the micro-wires 2a extend is transmitted whereas a linearly polarized light (the reflected light 80r) having a polarizing axis parallel to the direction in which the micro-wires 2a extend is reflected. The reflected light 80r, reflected by the wire grid polarization layer 2, enters the diffraction function layer 4 and is diffused. That is, the optical element of the embodiment has a polarization-separation function and a light-diffusion function and can further enhance the diffusion of transmitted light and reflected light.

In addition, as for the optical characteristics (light-diffusion characteristics) of the diffraction function layer 4, incident light can be diffused in a wider range by setting the thickness of the diffraction function layer 4 to a predetermined value according to the equation (1), for example. Further, the optical element 1 is superb in light stability since the wire grid polarization layer 2 performing a polarization separation is composed of micro-wires of aluminum.

The diffraction pattern (light scattering condition) of diffracted light achieved by the diffraction function layer 4 can be set by not only the thickness t but also the arrangement pattern of the first region 4a and the second region 4b, the size of each of the regions 4a and 4b, the refractive index difference, or the like.

When the optical element 1 is applied to a specific display device, the first region 4a and second region 4b of the diffraction function layer 4 may be completely randomly disposed overall in the diffraction function layer 4. Alternatively, a unit pattern in which the first regions 4a and the second regions 4b are disposed in a specific random distribution may be made and the unit pattern may be repeatedly disposed in a plurality of numbers in the diffraction function layer 4. The unit pattern may have any size. For example, the unit pattern may be a square having one side of 400 μm. According to such structure, a photomask used for manufacturing the diffraction function layer 4 can also employ a structure in which a mask pattern corresponding to the above-described unit pattern is repeatedly disposed, allowing the photomask to be easily made. As a result, the optical element is easily manufactured.

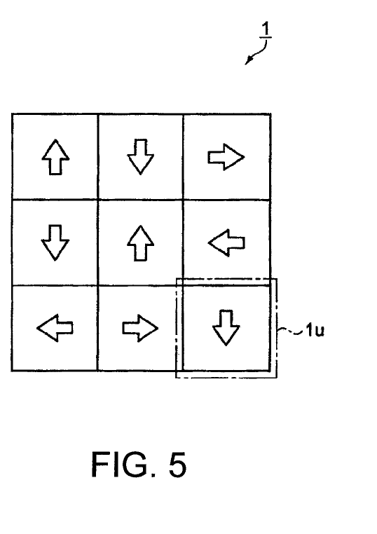

Also, as shown in FIG. 5, unit patterns 1u may be disposed so as to be adjacent and in directions different from each other. In FIG. 5, an arrow in each unit pattern 1u indicates the direction of the unit pattern 1u. Such arrangement can lower the periodicity of the diffraction function layer 4. As a result, the bias of the diffusion direction due to the repetition cycle of the unit pattern 1u can be dissolved. Also, coloring due to the diffraction can be reduced to an extent in which no problem occurs for practical use.

Method for Manufacturing an Optical Element

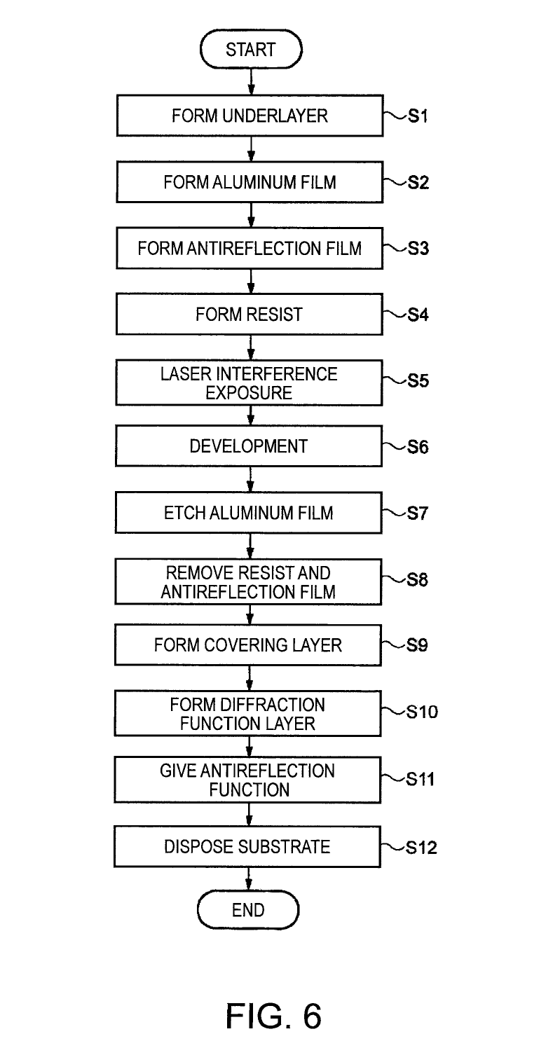

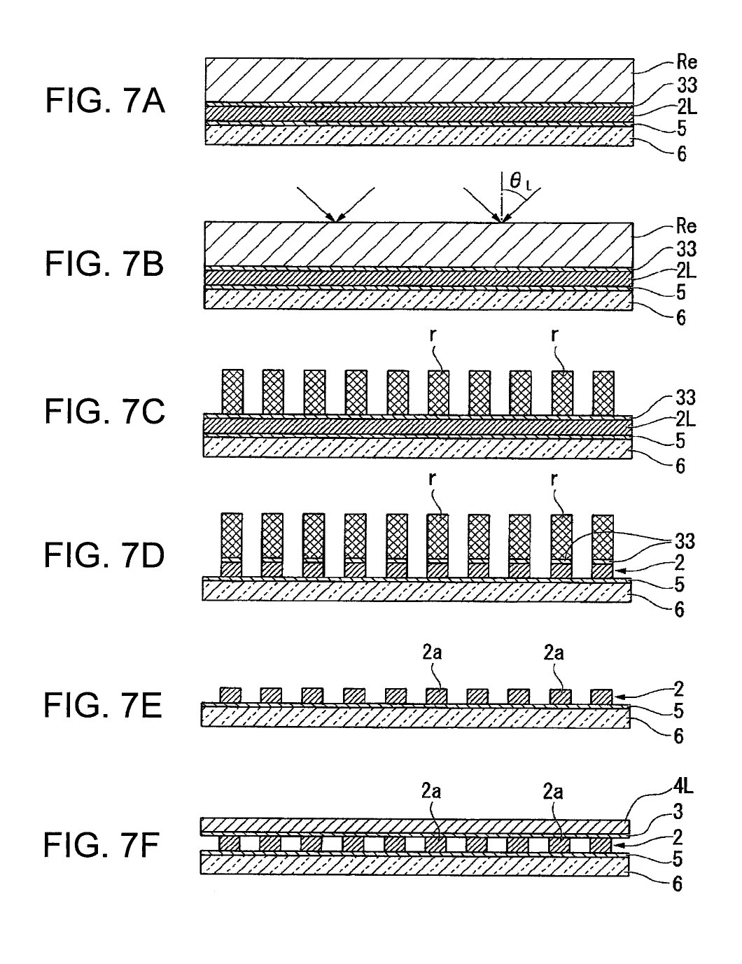

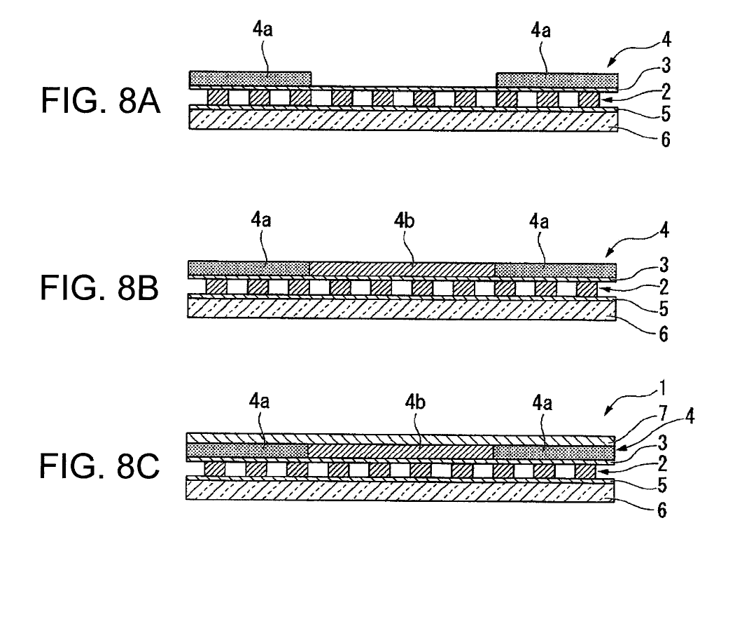

Referring now to FIGS. 6 to 8C, a method for manufacturing the optical element will be described. FIG. 6 is a flowchart of the method for manufacturing the optical element. FIGS. 7A to 8C are sectional views of the manufacturing steps of the optical element. The method will be described from step S1 to step S12 according to the flow chart in FIG. 6.

In step S1, the underlayer 5 is formed on the substrate 6 as shown in FIG. 7A.

In this step, for example, a silicon oxide film is formed on the substrate 6 made of glass with a thickness of about 0.7 mm by sputtering or the like as the underlayer 5.

In step S2, a conductor film with a thickness of 120 nm is formed on the underlayer 5 by sputtering or the like as an aluminum film 2L.

In step S3, an antireflection film 33 is formed on the aluminum film 2L by vacuum deposition, sputtering, or the like. Suitable examples of the material of the antireflection film 33 include SiC and SiOₓN_{y}:H (x, y are composition ratios). Indium tin oxide (ITO) may also be used. Organic coating materials used in a semiconductor field also may be used. The antireflection effect depends on the complex refractive index of raw materials. For example, the material having a complex refractive index of 1.4 or more in its real part and from 0.1 to 1.5 inclusive in its imaginary part is preferable.

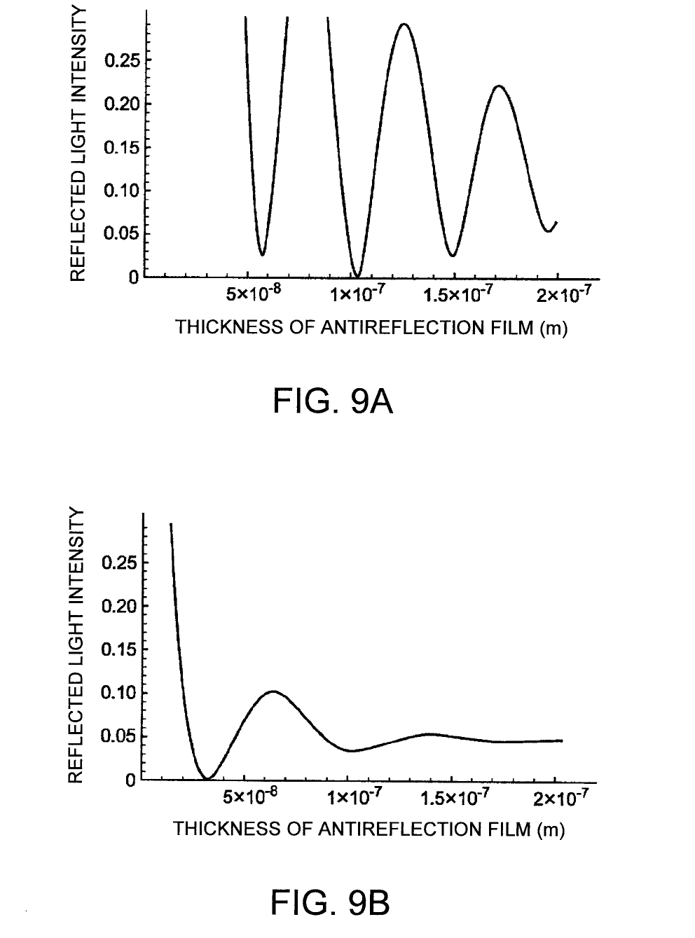

In this regard, FIGS. 9A and 9B are graphs showing the relations between the thickness of the antireflection film 33 and a reflected light intensity on the interface between a resist Re and antireflection film 33 when the resist Re is layered on the antireflection film 33 (FIG. 7A). FIG. 9A shows the relation when SiC is used as the antireflection film 33 and FIG. 9B shows the relation when SiOₓN_{y}:H is used as the antireflection film 33. Note that the optimum thickness of the antireflection film 33 varies depending on film-forming conditions even if the same material is used.

In step S4, the resist Re is formed on the antireflection film 33 by spin coating or the like as a plane having a nearly flat surface (FIG. 7A).

In step S5, the resist film Re is subjected to laser interference exposure (FIG. 7B) in such a manner that an area, in which the micro-wires are formed, of the wire grid polarization layer 2 is selectively exposed to form the latent image of micro-wires. The area is a minute linear area having a pitch of 140 nm. As a light source used for laser interference exposure, a continuously oscillating deep ultra violet (DUV) laser having a wavelength of 266 nm may be used. An incident angle θL may be, for example, 72 degrees. In this case, since the antireflection film 33 is formed under the resist film Re, so that incomplete exposure can be prevented that is caused by laser light reflected by the aluminum film 2L. Since the surface of the resist film Re is nearly a flat surface, the surface can be uniformly irradiated with laser light with a nearly equal power density. As a result, a resist pattern r can be formed with high shape and dimension accuracy in subsequent steps.

In step S6, the resist film Re having been subjected to laser interference exposure is developed. As a result, the resist pattern r is achieved that has a pitch of 140 nm and a minute linear shape (FIG. 7C).

In step S7, the aluminum film 2L is etched. More specifically, dry etching is performed with the resist pattern r as a mask so that the antireflection film 33 and aluminum film 2L are patterned (FIG. 7D). In subsequent step S8, the resist pattern r and the antireflection film 33 are removed. As a result, the wire grid polarization layer 2 composed of micro-wires arranged at a pitch of 140 nm is formed on the diffraction function layer 4 (FIG. 7E).

If SiO₂ (with a thickness of 30 nm) is previously formed between the aluminum film 2L and antireflection film 33, the etching selection ratio with respect to the aluminum film 2L is improved compared with that with respect to the resist. Thus, the thickness of the resist pattern r can be reduced. As a result, the resist pattern r can be stably formed.

In step 9, the covering layer 3 is formed on the wire grid polarization layer 2. In the step, a layer made of SiO₂, SiN, or the like is formed on the wire grid polarization layer 2, for example, by chemical vapor deposition (CVD), vacuum deposition, or the like under a vacuum environment. As a result, a space surrounded by the substrate 6 (underlayer 5), the wire grid polarization layer 2, and the covering layer 3 between the micro-wires 2a can be sealed in a vacuum state (FIG. 7F).

In step S10, a diffraction function material layer 4L is formed on the covering layer 3. In this step, first, the diffraction function material layer 4L made of polymer and having a given refractive index is layered on the covering layer 3 by spin coating or the like (FIG. 7F). The material, such as TiO₂, TaO₅, SiON, SiC, and Si₃N₄, used for forming the diffraction function material layer 4L can be film-formed by coating using metal alkoxide or the like.

Subsequently, areas corresponding to the second regions 4b of the diffraction function material layer 4L are selectively exposed with a photomask (not shown). Then, the exposed areas are removed by wet development so as to form the distribution of the first regions 4a on the covering layer 3 (FIG. 8A). The diffractive function material layer 4L may also be patterned by using dry development (dry etching).

Then, a diffraction function material having a refractive index different from that of the diffraction function material layer 4L (the refractive index is smaller than that of the diffraction function material layer 4L) is disposed to areas corresponding to the second regions 4b on the covering layer 3 so as to form the distribution of the second regions 4b (FIG. 8B). The diffraction function material is coated by spin coating, for example.

As a result, the diffraction function layer 4 having the first regions 4a and the second regions 4b that have different refractive indexes is formed on the substrate 6.

In step S11, the AR coat film 7 is formed on the surface of the diffraction function layer 4 so as to give an antireflection function. Consequently, the optical element 1 of the embodiment is achieved.

With the steps described above, the wire grid polarization layer 2 can be firmly and neatly formed above the substrate 6. According to the method, each surface of the aluminum film 2L and the resist Re is flat since the aluminum film 2L is formed on the plane surface of the substrate 6 and the resist Re is formed on the aluminum film 2L. Therefore, in patterning the resist Re according to the shape of the wire grid polarization layer 2 in step S4, few patterning defects occur that are related to insufficient exposure due to the film thickness variation of the resist Re and phase modulation of exposure light. Thus, the wire grid polarization layer 2 can be firmly formed on the substrate 6. As a result, the optical element 1 can be achieved that has good optical characteristics (polarization property of light).

While the aluminum film 2L is used as the conductor film in this embodiment, other metal materials such as silver and nickel may be used as the conductor film.

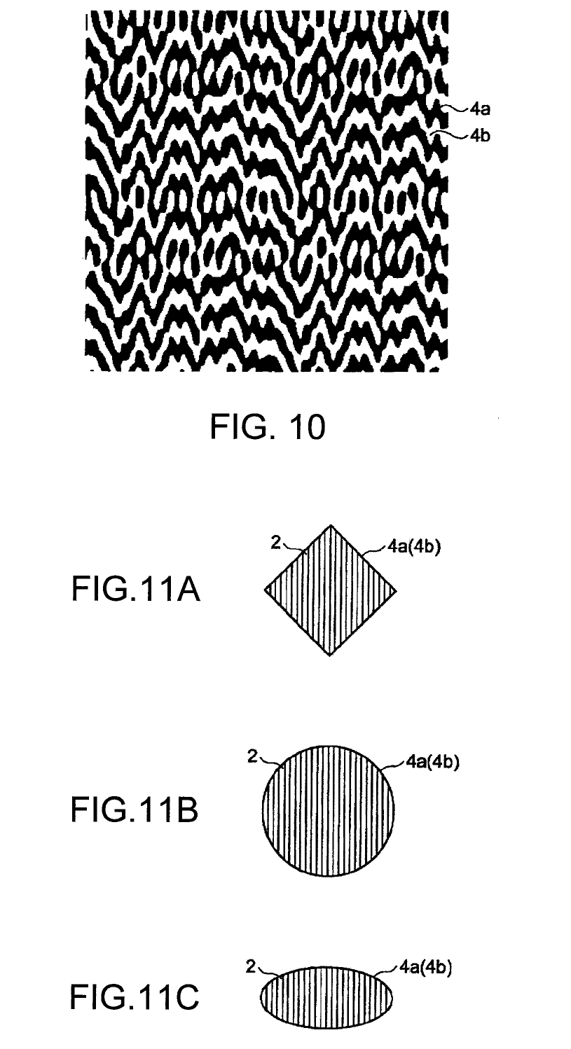

The shapes of the first regions 4a and the second regions 4b of the diffraction function layer 4 are not limited to those shown in FIG. 1. The shapes shown in FIG. 10 may be employed. In FIG. 10, black areas correspond to the first regions 4a and white areas correspond to the second regions 4b.

In the embodiment, each of the first regions 4a and the second regions 4b of the diffraction function layer 4 has a shape of square or linked square and the micro-wires included in the wire grid polarization layer 2 are in parallel with one of the sides of the square. However, the first regions 4a and the second regions 4b may have other structures.

FIGS. 11A to 11C are drawings showing examples of the relation between the shape (hereafter referred to as a “unit shape”) of the unit of the first regions 4a and second regions 4b of the diffraction function layer 4 and the extending direction of the micro-wires included in the wire grid polarization layer 2.

FIG. 11A shows a structure in which the unit shape is a square. In the structure, one side of the square of the unit shape makes an angle of 45 degrees with respect to the extending direction of the micro-wires of the wire grid polarization layer 2 and the straight line shaped boundary of the unit shape is nonparallel with the micro-wires. FIG. 11B shows the unit shape of a circle. FIG. 11C shows the unit shape of an ellipse.

The unit shape of a circle can achieve an isotropic reflected light intensity distribution. In contrast, the shape of reflected light intensity distribution can have anisotropy with the unit shape having anisotropy, such as a rectangle and an ellipse. In this case, the width of the distribution is expanded in the narrow width direction of each unit shape, while the width of the distribution is reduced in the wide width direction of each unit shape.

Liquid Crystal Device

A liquid crystal device having the optical element according to the invention as a reflective polarizing layer embedded therein is now described with reference to the accompanying drawings.

The liquid crystal device of another embodiment of the invention employs what is called a fringe-field switching (FFS) method, which is one of the horizontal electric field methods displaying images by applying an electric field (a horizontal electric field) to liquid crystal in a substrate surface direction to control the alignment thereof. The liquid crystal device according to this embodiment is also a color liquid crystal device having a color filter on a substrate.

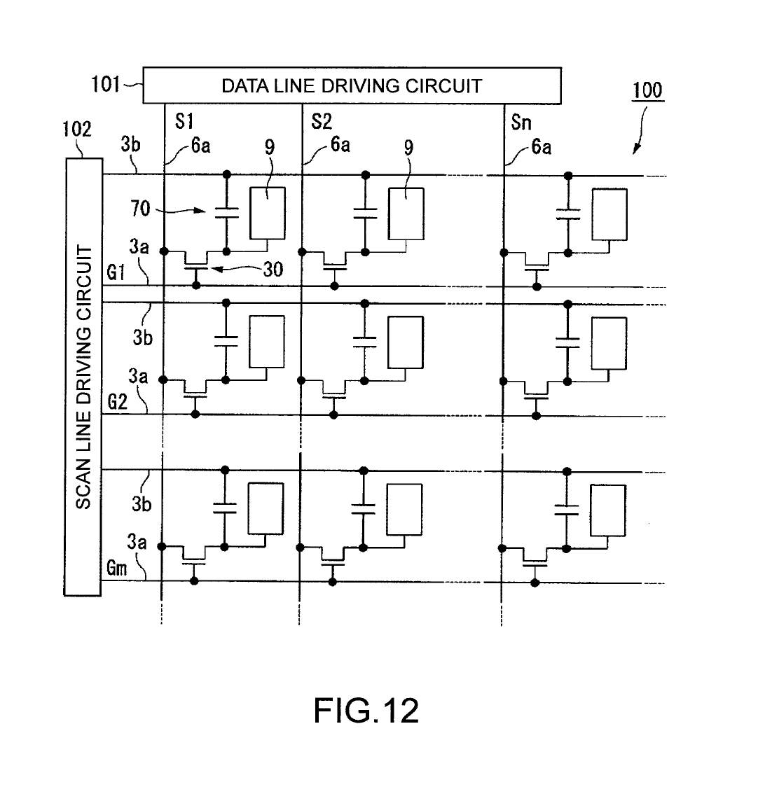

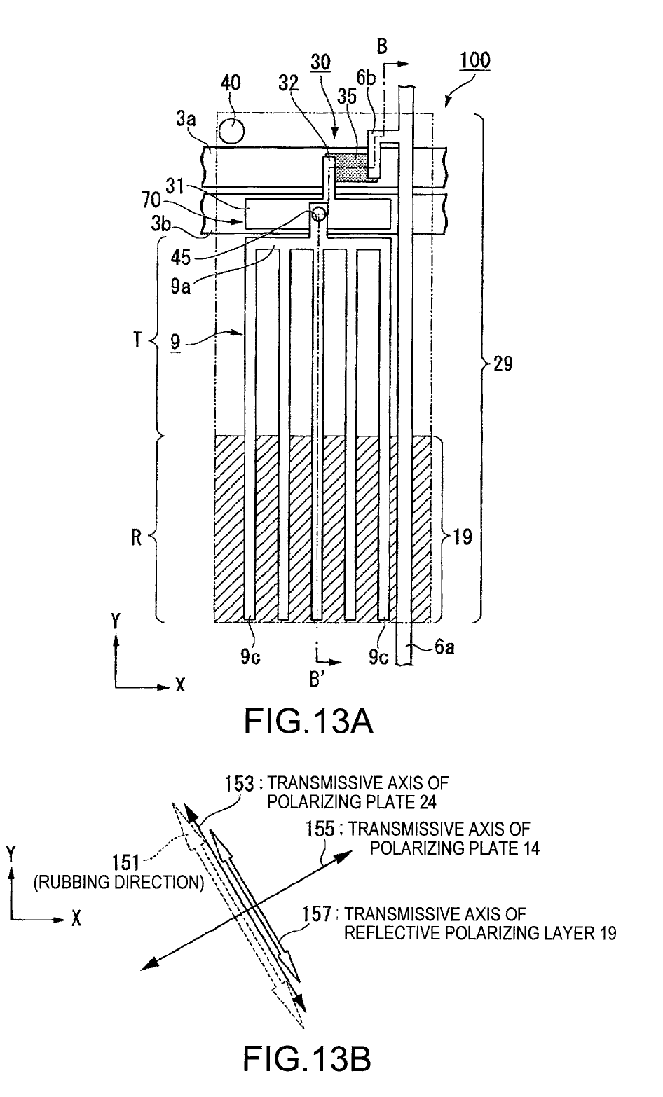

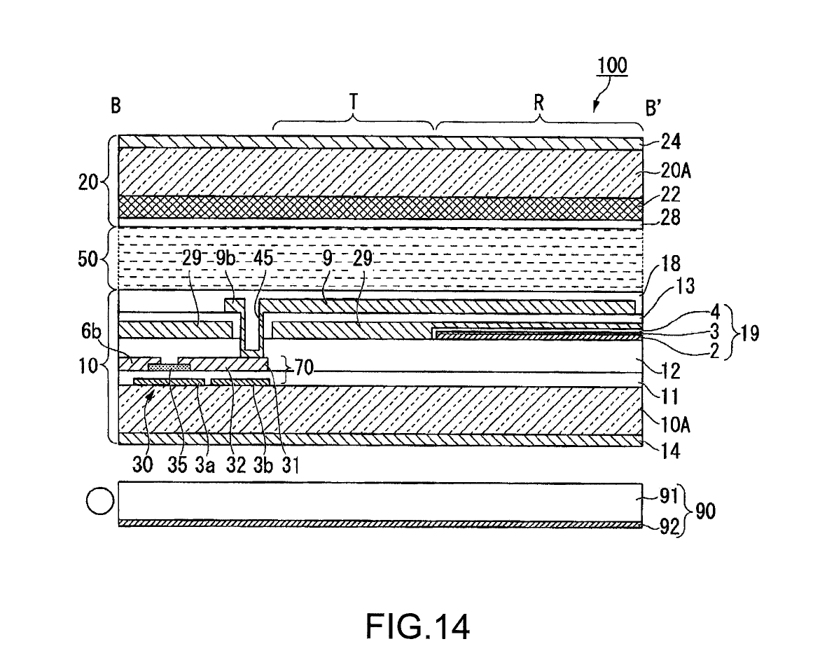

FIG. 12 is an equivalent circuit diagram of a plurality of sub-pixel regions arranged in a matrix and included in a liquid crystal device 200 according to the embodiment. FIG. 13A is a plan view showing an arbitrary single sub-pixel region of the liquid crystal device 200. FIG. 13B is an explanatory view showing an arrangement relationship between the optical axes of optical elements included in the liquid crystal device 200. FIG. 14 is a partial sectional view taken along the line B-B′ in FIG. 13A.

In each drawing, layers and members are shown in different scales so as to make them recognizable. In the following descriptions, FIGS. 1A, 1B, and 2 are arbitrarily referred for the descriptions.

As shown in FIG. 12, in each of the sub-pixel regions formed in the matrix, which region constitutes the image display region of the liquid crystal device 200, a pixel electrode 9 and a thin film transistor (TFT) 30 performing a switching control of the pixel electrode 9 are formed. A data line 6a extended from a data line driving circuit 101 is electrically connected to the source of the TFT30. The data line driving circuit 101 supplies image signals S1, S2, . . . , Sn respectively to corresponding pixels through the data line 6a. The image signals S1, S2, . . . , Sn may be supplied in a line-sequentially in this order or they may be provided by groups corresponding to a set of adjacent data lines 6a.

A gate of the TFT 30 is electrically connected to a scan line 3a extending from a scan line driving circuit 102. Scan signals G1, G2, . . . , Gm are supplied as a pulse respectively to corresponding scan lines 3a at a predetermined timing from the scan line driving circuit 102 and applied in a line-sequentially to corresponding gate of the TFTs 30. The pixel electrode 9 is electrically connected to a drain of the TFT 30. When one of the TFTs 30 serving as a switching element is placed in an ON state only during a predetermined period of time by inputting one corresponding scan signal from the scan signals G1, G2, . . . , Gm, one corresponding image signal from the image signals S1, S2, . . . , Sn supplied from the data lines 6a is written into the pixel electrode 9 at a predetermined timing.

Each of the image signals S1, S2, . . . , Sn having a predetermined level written in liquid crystal through the pixel electrode 9 is stored, in a certain period of time, between the pixel electrode 9 and a common electrode opposed to the pixel electrode 9 with the liquid crystal interposed therebetween. In order to prevent leakage of the stored image signal, a storage capacitance 70 is added parallel to a liquid crystal capacitance formed between the pixel electrode 9 and the common electrode. The storage capacitance 70 is provided between the drain of the TFT 30 and a capacitance line 3b.

Next, a detailed structure of the liquid crystal device 100 will be described by referring to FIGS. 13A, 13B and 14.

As shown in FIG. 14, the liquid crystal device 100 includes a liquid crystal panel having a TFT array substrate 10 (base material), a counter substrate 20 (base material) and a liquid crystal layer 50 interposed between the TFT array substrate 10 and the counter substrate 20. The liquid crystal layer 50 is sealed between the substrates 10 and 20 with a sealing material (not shown) provided along an edge of a region where the TFT array substrate 10 and the counter substrate 20 face each other. A backlight 90 including a light guiding plate 91 and a reflecting plate 92 is provided to a side adjacent to the back surface of the TFT array substrate 10.

As shown in FIG. 13A, in the sub-pixel region of the liquid crystal device 100, a pixel electrode 9 and a common electrode 29 are provided. The pixel electrode 9 has a longitudinal comb-teeth-like shape in plan view in an extending direction (Y-axis direction) of the data line 6a. The common electrode 19 is nearly flatly formed and is overlapped with the pixel electrode 9 in plan view. At the upper left corner of the sub-pixel region in FIG. 13A, a columnar spacer 40 is provided upright by which the TFT array substrate 10 and the counter substrate 20 are kept spaced apart from each other with a predetermined distance.

The pixel electrode 9 includes a base end part 9a, a contact part 9b, and a strip electrode part 9c. The strip electrode part 9c extends in the direction in which the data line 6a extends and provided in a plurality of numbers (5 strip electrode parts in FIG. 13A). The base end part 9a is connected to each edge at a side adjacent to the TFT 30 of the strip electrode parts 9c and extends in the direction in which the scan line 3a extends. The contact part 9b (refer to FIG. 14) extends from the central portion of the base end part 9a in the extending direction of the scan line 3a to a side adjacent to the TFT 30.

The common electrode 29 is a transparent electrode that is flatly formed in the pixel region shown in FIG. 14. A reflective polarizing layer 19 is formed in the area overlapping with a part of the common electrode 29 in plan view. The reflective polarizing layer 19 includes the optical element of the invention. That is, the reflective polarizing layer 19 is provided with the wire grid polarization layer 2 including the micro-wires 2a having a micro slit structure and light reflectivity (refer to FIGS. 1A, 1B and 2).

The common electrode 29 may have a nearly rectangular shape in plan view with a nearly same size of the sub-pixel region. In this case, a common electrode wiring line extending across a plurality of common electrodes may be provided to electrically connect the common electrodes arranged in an extending direction of the common electrode wiring line. The liquid crystal device 100 according to the embodiment is structured, in the single sub-pixel region shown in FIG. 13A, as follows. An area where the reflective polarizing layer 19 is formed serves as a reflective display region R. The area is a part of the planar region having the nearly rectangular shape in which region the pixel electrode 9 is provided. In the reflective display region R, light that is entered from the outside of the counter substrate 20 and passes through the liquid crystal layer 50 is reflected and modulated. In the region where the pixel electrode 9 is provided, another area serves as a transmissive display region T. In the area, the reflective polarizing layer 19 is not formed so as to transmit light. In the transmissive display region T, light that is entered from the backlight 90 and passes through the liquid crystal layer.

The TFT 30 is connected to the data line 6a that extends in the longitudinal direction (the X-axis direction) of the pixel electrode 9 and to the scan line 3a that extends in a direction orthogonal to the data line 6a (the Y-axis direction). The capacitance line 3b that extends in parallel and adjacent to the scan line 3a is provided. The TFT 30 includes a semiconductor layer 35, a source electrode 6b and a drain electrode 32. The semiconductor layer 35 is partially formed in a planar region of the scan line 3a and made of an amorphous silicon film. The source electrode 6b and the drain electrode 32 are formed so as to partially overlap with the semiconductor layer 35 in plan view. The scan line 3a serves as a gate electrode of the TFT 30 at a position where the line 3a overlaps with the semiconductor layer 35 in plan view.

The source electrode 6b of the TFT 30 is branched from the data line 6a and extended to the semiconductor layer 35 so as to be formed a nearly reversed-L shape in plan view. The drain electrode 32 extends from a position where the electrode 32 overlaps with the semiconductor layer 35 in plan view to a side adjacent to the pixel electrode 9, and an end of the drain electrode 32 is electrically connected to a capacitance electrode 31 having a nearly rectangular shape in plan view. On the capacitance electrode 31, the contact part 9b protruding toward a side adjacent to the scan line 3a at an end of the pixel electrode 9 (refer to FIG. 14). The capacitance electrode 31 and the pixel electrode 9 are electrically connected with a pixel contact hole 45 formed at a position where the electrode 31 and the electrode 9 are overlapped. The capacitance electrode 31 is disposed in a planar region of the capacitance line 3b to form the storage capacitance 70 having the capacitance electrode 31 and the capacitance line 3b as the electrodes. The capacitance electrode 31 and the capacitance line 3b face each other in a thickness direction of the capacitance electrode 31.

The liquid crystal device 100 of the embodiment is the FFS method liquid crystal device having the pixel electrode 9 and the common electrode 29 opposing the pixel electrode 9. Therefore, a relatively large capacitance is formed in the area where the pixel electrode 9 and the common electrode 29 overlap each other in plan view when a voltage is applied to the pixel electrode 9 in a display operation. Thus, in the liquid crystal device 100, the storage capacitance 70 may be omitted. This structure allows a formation region of the capacitance electrode 31 and the capacitance line 3b to be used also for a display, thereby improving a sub-pixel aperture ratio to increase the brightness of the display.

As can be seen from a sectional structure shown in FIG. 14, the liquid crystal layer 50 is provided between the TFT array substrate 10 and the counter substrate 20 that are opposed. The TFT array substrate 10 includes a substrate main body 10A that is made of glass, quartz or plastic and transmits light. The substrate main body 10A has the scan line 3a and the capacitance line 3b on its surface at a side adjacent to the liquid crystal layer 50. A gate insulation film 11 made of a transparent insulation film such as silicon oxide is formed so as to cover the scan line 3a and the capacitor line 3b.

On the gate insulation film 11, the semiconductor layer 35 made of amorphous silicon is formed. The source electrode 6b and the drain electrode 32 are provided in a manner of being partially placed on the semiconductor layer 35. The capacitance electrode 31 is formed integrally with the drain electrode 32.

The semiconductor layer 35 is disposed so as to oppose the scan line 3a with the gate insulation film 11 interposed therebetween. In a region between the semiconductor layer 35 and the scan line 3a that are opposed, the scan line 3a serves as the gate electrode of the TFT 30. The capacitance electrode 31 is disposed so as to oppose the capacitance line 3b with the gate insulation film 11 interposed therebetween. In a region where the capacitance electrode 31 and the capacitance line 3b are opposed, a storage capacitance 70 having the gate insulating film 11 as a dielectric film thereof is formed.

An interlayer insulation film 12 made of silicon oxide or the like is formed so as to cover the semiconductor layer 35, the source electrode 6b, the drain electrode 32 and the capacitance electrode 31. On the interlayer insulation film 12, the reflective polarizing layer 19 serving as the optical element of the invention is partially formed. The reflective polarizing layer 19 includes the wire grid polarization layer 2 shown in FIGS. 1A, 1B, and 2, the covering layer 3, and the diffraction function layer 4. In the embodiment, the micro-wires 2a (referred to FIGS. 1A, 1B, and 2) included in the wire grid polarization layer 2 are made of aluminum, and the diffraction function layer 4 covering the wire grid polarization layer 2 is made of a polymer.

The common electrode 29 made of a transparent conductive film is flatly formed on the interlayer insulation film 12 and the reflective polarizing layer 19. The diffraction function layer 4, which is a transparent insulation film, isolates the common electrode 29 from the wire grid polarization layer 2 of the reflective polarizing layer 19.

An electrode part insulation film 13 made of silicon oxide or the like is formed so as to cover the common electrode 29. The pixel electrode 9 made of a transparent conductive material such as ITO is formed on the electrode part insulating film 13. A pixel contact hole 45 penetrates through the interlayer insulation film 12 and the electrode part insulation film 13 to reach the capacitance electrode 31. The contact part 9b of the pixel electrode 9 is partially embedded in the pixel contact hole 45 to electrically connect the pixel electrode 9 and the capacitance electrode 31. An opening is formed at least to the common electrode 29 corresponding to a formation region of the pixel contact hole 45, so that the common electrode 29 does not make contact with the pixel electrode 9. In addition, an alignment film 18 (horizontal alignment film) made of polyimide or the like is formed so as to cover the pixel electrode 9.

The counter substrate 20 includes a substrate main body 20A that is made of glass, quartz or plastic and transmits light. At the inner side of the counter substrate 20 (at a side adjacent to the liquid crystal layer 60), a color filter 22 and an alignment film 28 (horizontal alignment film) are layered. At the outer face side of the counter substrate 20, a polarizing plate 24 is provided. The polarization plate 24 is the counterpart of the polarizing plate 14 provided at the outer face side of the TFT array substrate 10.

Preferably, the color filter 22 is partitioned into two regions having different colors in the pixel region. That is, it is preferable that a first color material region corresponding to the transmissive display region T and a second color material region corresponding to the reflective display region R be partitioned. In this case, the first color material region arranged in the transmissive display region T has a color density greater than that of the second color material region. This manner can prevent the color difference of display light between the transmissive display region in which the display light passes through the color filter 22 only once and the reflective display region in which the display light passes through the color filter 22 twice. Thus, visual quality can be maintained equal in the reflective display and the transmissive display, thereby improving display quality.

As shown in the arrangement diagram of optical axes of FIG. 13B, the reflective polarizing layer 19 of the liquid crystal device 100, is disposed so that a transmissive axis 157 (a direction orthogonal to the extending direction of the micro-wires 2s shown in FIGS. 1A, 1B, and 2) of the layer 19 is positioned parallel to a transmissive axis 153 of the polarizing plate 24 of the counter substrate 20, and orthogonal to the transmissive axis 155 of the polarizing plate 14 of the TFT array substrate 10. Additionally, in the liquid crystal device 100 of the embodiment, alignment films 18 and 28 are subjected to rubbing treatment in the same direction in plan view, and the direction is a rubbing direction 151 shown in FIG. 13B. Thus, the transmissive axis 157 of the reflective polarizing layer 19 is parallel to the rubbing direction 151 of the alignment films 18 and 28.

The rubbing direction 151 makes an angle of about 30 degrees with respect to the strip electrode part 9c extending parallel to the pixel arrangement direction (Y-axis direction) of the liquid crystal device 100.

The liquid crystal device 100 structured as above is the FFS-method liquid crystal device. Thus, when an image signal (voltage) is applied to the pixel electrode 9 via the TFT 30, an electric filed is produced between the pixel electrode 9 and the common electrode 29 in the substrate surface direction (X-axis direction in FIGS. 13A and 13B in plan view). Then, liquid crystal molecules are driven by the resulting electric field to change the transmittance/reflectance of each sub-pixel, thereby displaying images.

The alignment films 18 and 28 that are opposed with the liquid crystal layer 50 interposed therebetween are processed with rubbing in the same direction in plan view. The liquid crystal molecules forming the liquid crystal layer 50 horizontally align along the rubbing direction between the substrates 10 and 20 when a voltage is not applied to the pixel electrode 9. When the electric field produced between the pixel electrode 9 and the common electrode 29 is applied to the liquid crystal layer 50 having the liquid crystal molecules aligned in the above state, the liquid crystal molecules are re-aligned in the line width direction (X-axis direction) of each strip electrode part 9c shown in FIG. 13A. The liquid crystal device 100 takes advantage of birefringence based on the different alignment states of the liquid crystal molecules to perform bright and dark display states. When the liquid crystal device 100 operates, it is only necessary to maintain a voltage of the common electrode 29 at a certain level so as to provide a voltage difference within a predetermined range between the common electrode 29 and the pixel electrode 9.

The liquid crystal device 100 of the embodiment also has the reflective polarizing layer 19 corresponding to the reflective display region. Therefore, a fine contrast can be obtained both in the transmissive display and the reflective display without using a multi-gap structure. The reflective polarizing layer 19 employs the wire grid type optical element according to the invention. In the optical element, the wire grid polarization layer 2 is covered with the covering layer 3, on which the diffraction function layer 4 is formed (refer to FIGS. 1A, 1B, and 2). This structure can prevent the common electrode 29 formed on the reflective polarizing layer 19 from entering the openings (refer to FIG. 2) in the wire grid polarization layer 2, preventing the optical characteristics of the reflective polarizing layer 19 from being lowered. Consequently, optical characteristics superior in both transmissivity and contrast (polarization selectivity) can be obtained in the reflective polarizing layer 19.

In addition, since the reflective polarizing layer 19 has a flat surface, the thickness variation of the liquid crystal layer 50 in a plane can be reduced. As a result, contrast deterioration of images conventionally caused by the thickness variation of the liquid crystal layer 50 can be prevented. Further, visibility can be improved since the reflective polarizing layer 19 has a light scattering function. In this way, the liquid crystal device 100 of the embodiment can achieve a reflective display with high contrast.

The liquid crystal device 100 of the embodiment includes the liquid crystal layer having a constant thickness between the transmissive display region T and the reflective display region R that serve as a display portion. This structure does not cause a difference in the driving voltage in two regions and effectively prevents a different display state between the reflective display and the transmissive display.

The reflective polarizing layer 19 to perform a reflective display is provided in the TFT array substrate 10. This structure can effectively prevents display quality from being deteriorated because outside light is not reflected by metal wiring lines and the like that are formed on the TFT array substrate 10 together with the TFT 30. The pixel electrode 9 made of the transparent conductive material can also prevent outside light inputted to the TFT array substrate 10 after passing through the liquid crystal layer 50 from being diffusely reflected by the pixel electrode 9. As a result, excellent visibility can be achieved.

Projector

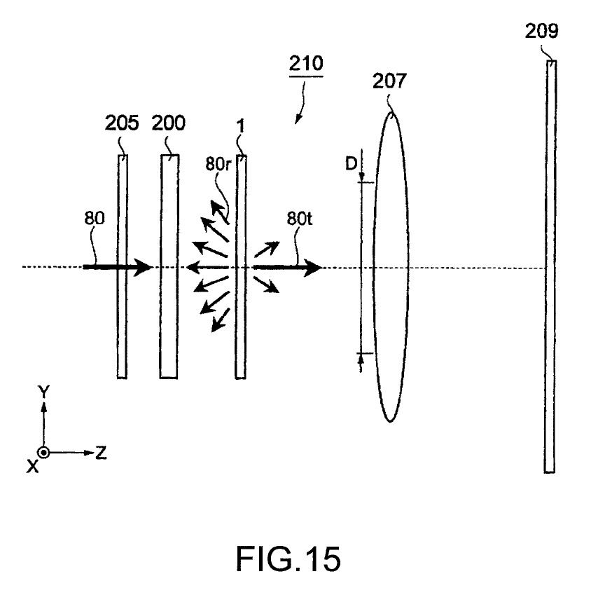

Next, a case will be described in which the optical element of the invention is applied to a projection display device. FIG. 15 is a schematic view showing an optical system of a projector 210, which is one of the projection display devices. In the projector 210, light emitted from a light valve is modulated by a liquid crystal device 200 and the modulated light is projected forward from a projection lens 207.

In FIG. 15, a dashed line shows the path of light emitted from a light source in the projector 210. In the light path, a wire grid polarization element 205, the liquid crystal device 200, the optical element 1, and the projection lens 207 are disposed in this order. In other words, the optical element 1 is disposed at any position in the light path from the liquid crystal device 200 to the projection lens 207. After the projection lens 207 in the light path, a screen 209 is disposed. In the projector 210, a display in the liquid crystal device 200 is enlarged and projected to the screen 209 through the projection lens 207.

The wire grid polarization element 205 has a plurality of micro-wires each of which is made of a conductive material and disposed parallel on a substrate having transparency. The wire grid polarization element 205 functions as follows: a light component having a polarization axis parallel to the micro-wires in the incident light 80 is reflected and a light component having a polarization axis perpendicular to the micro-wires of the incident light 80 is transmitted. That is, the wire grid polarization element 205 has a polarization—separation function. The wire grid polarization element 205, however, does not have a function to diffuse reflected light and transmitted light because it is simply structured to have micro-wires formed on a flat substrate. Among light components of the incident light 80, a light component after passing through the wire grid polarization element 205 mostly enters the liquid crystal device 200 without being diffused.

The liquid crystal device 200 includes an element substrate, a counter substrate, and liquid crystal. The liquid crystal is sealed between the element substrate and the counter substrate that are bonded together with a sealant having a frame shape. The liquid crystal changes its alignment state by a driving voltage applied through electrodes formed on the opposing surfaces of the element substrate and the counter substrate. The liquid crystal device 200 can change the polarization state of the transmitted light according to the alignment states of the liquid crystal.

Light after passing through the liquid crystal device 200 enters the optical element 1. As described above, the optical element 1 functions as follows: a light component having a polarization axis perpendicular to the micro-wires of the wire grid polarization layer 2 is transmitted to enter the projection lens 207 and a light component having a polarization axis parallel to the micro-wires of the wire grid polarization layer 2 is reflected. The optical element 1 is preferably disposed so as to be apart from the liquid crystal device 200 as much as possible in order to reduce problems caused by the reflected light 80r.

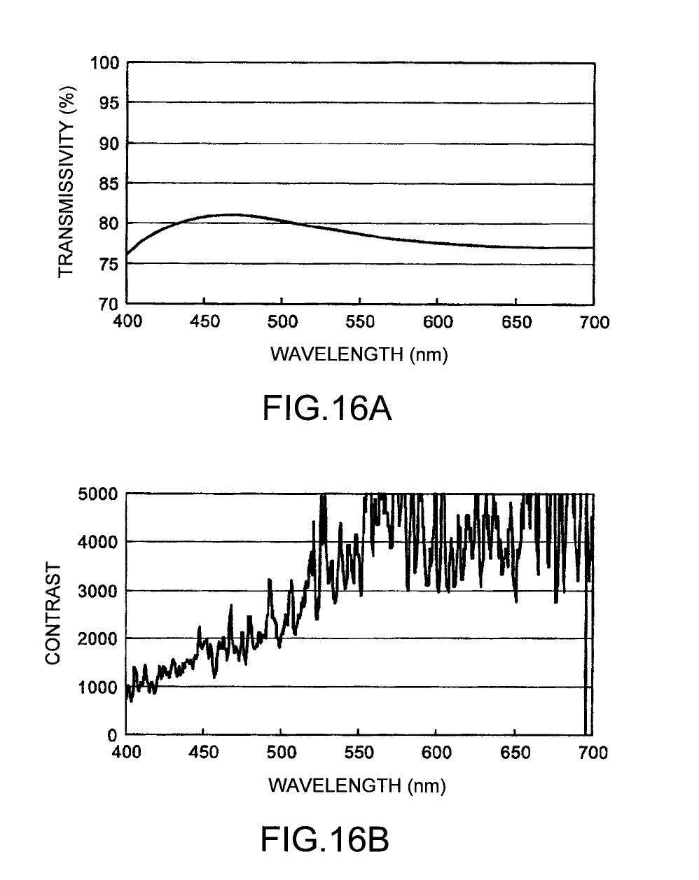

When the optical element 1 is applied to projectors, light transmitting characteristics are important. FIGS. 16A and 16B are graphs showing light transmitting characteristics of the optical element 1. FIG. 16A shows the wavelength dependence of light transmissivity. FIG. 16B show the wavelength dependence of contrast. Here, contrast is defined by a ratio of the intensity of the component s (refer to FIG. 3B) to the intensity of the component p of light passing through the optical element 1. As can be seen from FIGS. 16A and 16B, the light transmissivity and the contrast are in a trade-off relation. For example, if it is intended to increase the contrast the light transmissivity is slightly lowered.

Modification of Projector

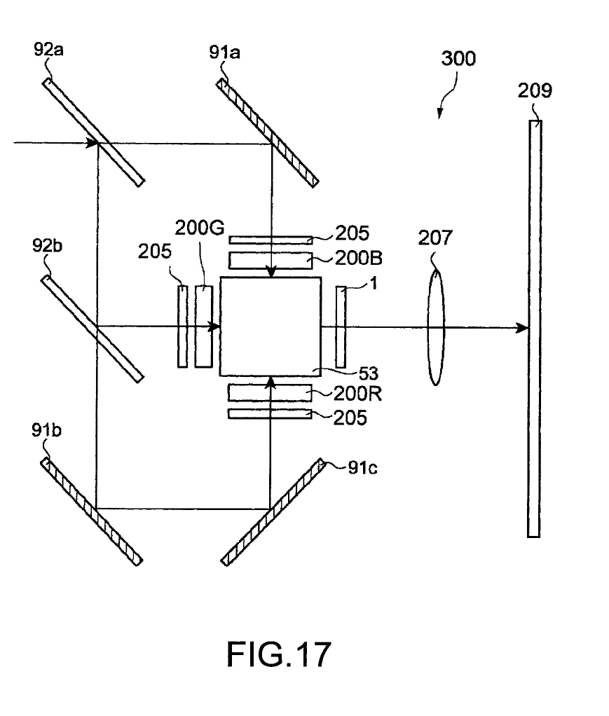

Modification of projector provided with the optical element of the invention will be described with reference to FIG. 17. In the following description, the same numeral is given to the same structure as that of the above-described embodiments.

The projector 210 may include the liquid crystal device 200 of a plurality of numbers. FIG. 17 is a schematic view showing an optical system of the projector 210 having three liquid crystal devices 200. This optical system includes a prism 53 having 4 faces, the optical element 1 disposed so as to face one of the faces of the prism 53, and the liquid crystal devices 200R, 200G, and 200B each of which faces one of three faces of the prism 53 other than the face that the optical element 1 faces.

Light components entering to the prism 53 from the liquid crystal devices 200R, 200G, and 200B are refracted by the prism 53 and each light component enters the optical element 1. In other words, the prism 53 is disposed in light paths from each of the liquid crystal devices 200R, 200G, and 200B to the optical element 1. The liquid crystal devices 200R, 200G, and 200B intensity modulate a red light component, a green light component, and a blue light component respectively. The intensity modulated light components are synthesized by the prism 53 to from display light. The wire grid polarization element 205 is disposed at each side facing the prism 53 across each of the liquid crystal devices 200R, 200G, and 200B. The optical system further includes the projection lens 207 that light emitted from the optical element 1 enters, mirrors 91a, 91b, and 91c, and dichroic mirrors 92a and 92b. The projection lens 207 is disposed in an extending line of the light path from the prism 53 to the optical element 1.

Light emitted from a light source (not shown) enters the dichroic mirror 92a and only a blue light component passes through the mirror 92a. The blue light component is reflected by the mirror 91a and successively passes through the wire grid polarization element 5 and the liquid crystal device 200B. Remaining light components deflected by the dichroic mirror 92a enter the dichroic mirror 92b and a green light component is reflected by and a red light component passes through the mirror 92a. The green light component successively passes through the wire grid polarization element 205 and the liquid crystal device 200G. The red light component is reflected by the mirror 91b and the mirror 91c and successively passes through the wire grid polarization element 205 and the liquid crystal device 200R. The red light component after passing through the liquid crystal device 200R, the green light component after passing through the liquid crystal device 200G, and the blue light component after passing through the liquid crystal device 200B enter the prism 53 and are changed their traveling directions so as to be emitted toward the optical element 1.

As described above, the optical element 1 functions as follows: among incident light, a light component having a polarization axis perpendicular to the micro-wires of the wire grid polarization layer 2 is transmitted to enter the projection lens 207 and a light component having a polarization axis parallel to the micro-wires of the wire grid polarization layer 2 is reflected. Here, reflected light is widely diffused by the diffraction function layer 4 to enter the prism 53 and each of the liquid crystal devices 200R, 200G, and 200B while keeping the diffused state. As a result, the reflected light does not hinder the stable operations of the liquid crystal devices 200R, 200G, and 200B. In addition, the transmitted light is enough depressed so as not to be diffused. Accordingly, light reaches the screen 209 with little light amount loss. Consequently, a projector 300 can be achieved that has bright display and long product life.

Electronic Apparatus

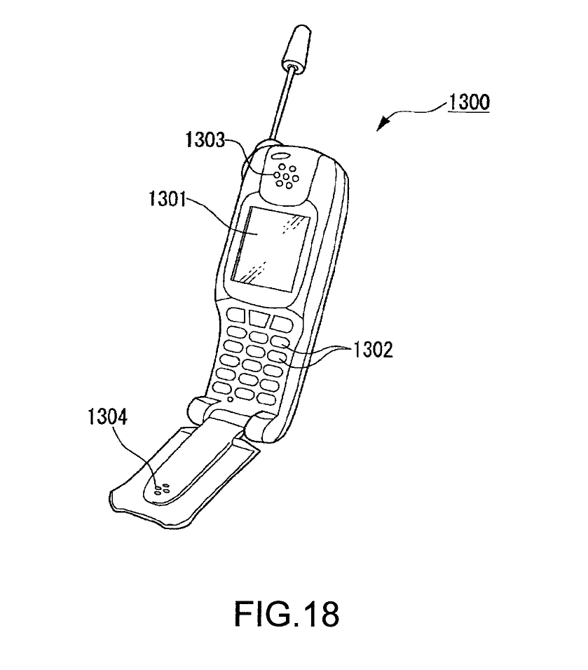

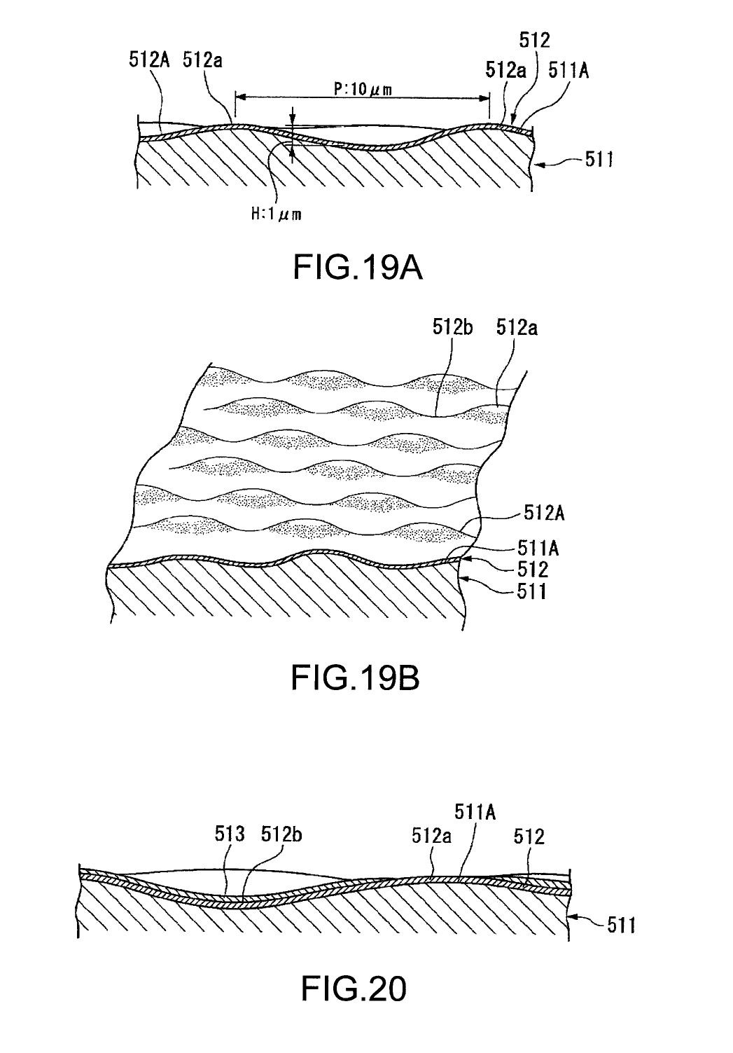

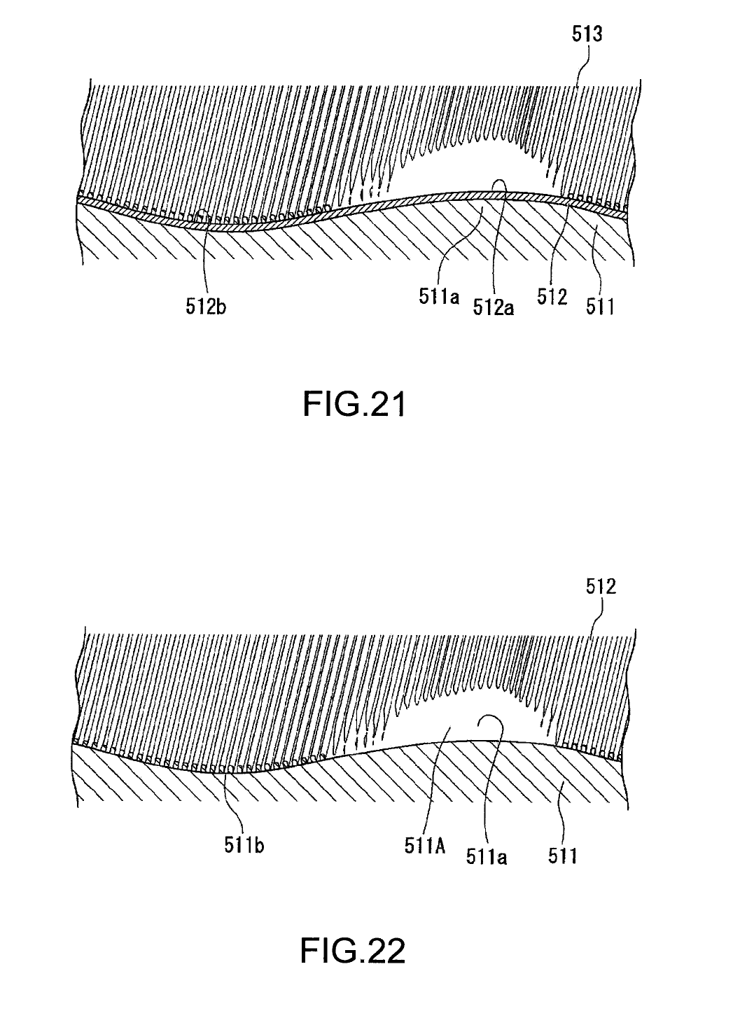

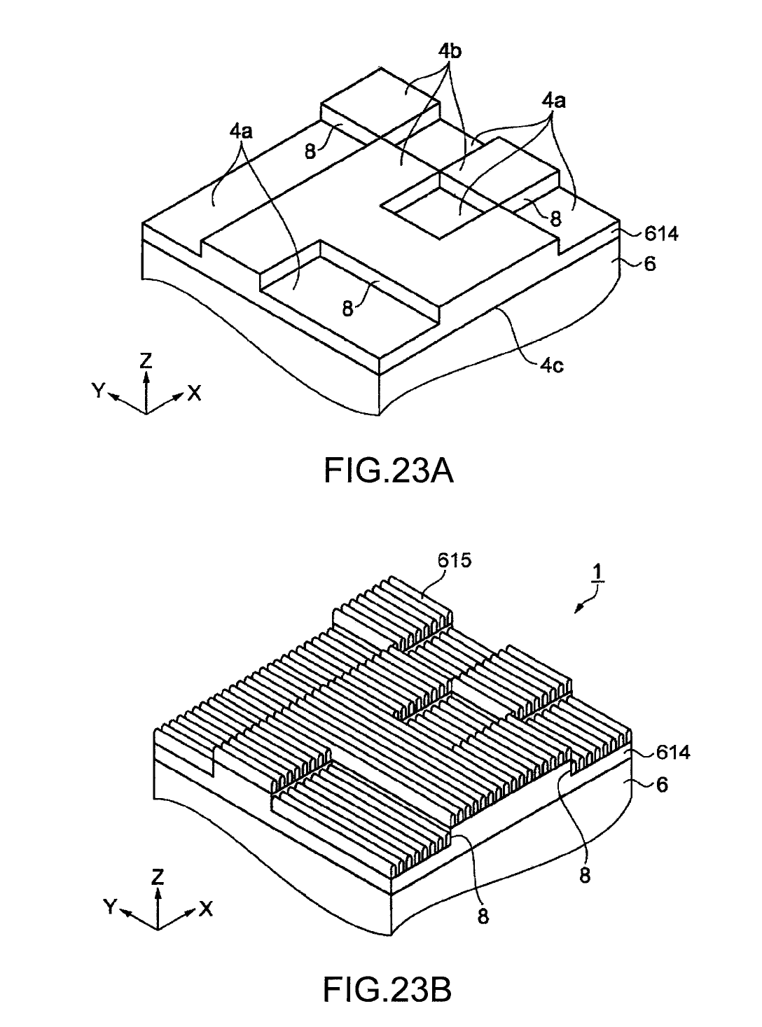

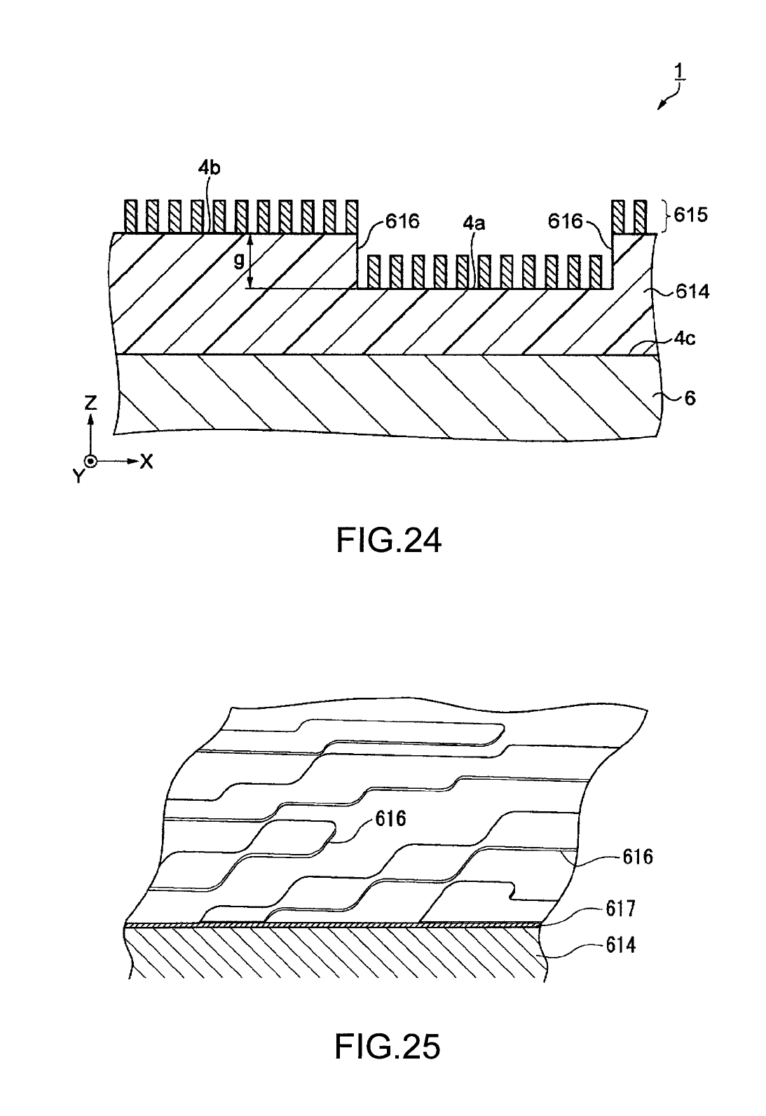

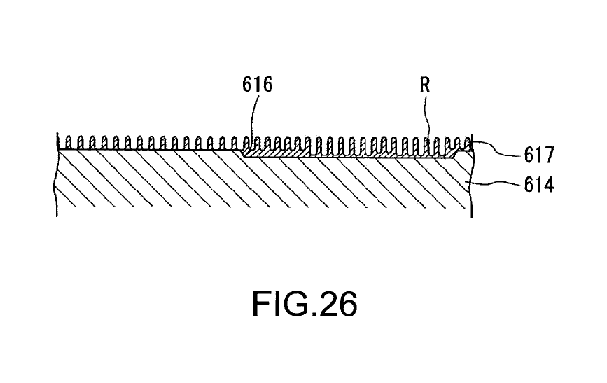

FIG. 18 is a perspective view of a cellar phone that is an example of the electronic apparatus having the liquid crystal device of the invention is used as a display. A cellar phone 1300 includes a small size display 1301 that is the liquid crystal device of the above-described embodiment, a plurality of manual operation buttons 1302, an earpiece 1303 and a mouthpiece 1304.

In addition to the above cellar phone, as an image display device, the liquid crystal device of the embodiment may be suitably applied to electronic books, personal computers, digital still cameras, liquid crystal television sets, view-finder type or monitor direct-view-type video tape recorders, car navigation devices, pagers, electronic organizers, electronic calculators, word processors, work stations, video phones, point of sale (POS) terminals, devices equipped with a touch panel, or the like. Any of the electronic apparatuses can provide transmissive and reflective displays with a high luminance, high contrast and a wide view angle.

Although the preferred embodiments of the invention have been described with reference to the accompanying drawings, the invention is not limited to those embodiments. Each embodiment may be combined. Naturally, those skilled in the art will able to presume many variations and modifications within the purview of the technical idea disclosed in the scope of claims of the invention. It will be understood that those variations and modifications are obviously within the technical scope of the invention.

For example, the diffraction function layer 4 may also have the function of the covering layer 3. This structure can eliminate the covering layer 3, achieving cost reduction with reducing the number of parts and increasing the yield rate.

What is claimed is:

1. An optical element, comprising:
a substrate;
a grid formed on the substrate, the grid including a plurality of micro-wires and having a polarization-separation function; and
a diffraction function layer formed above the grid, wherein the diffraction function layer has at least two kinds of regions in a plane, and at least the two kinds of regions have different refractive indexes.

2. The optical element according to Claim 1, wherein the regions are irregularly arranged in a direction of the plane.

3. The optical element according to Claim 1, wherein a unit pattern in which the two regions are irregularly arranged in the plane direction is arranged in a plurality of numbers.

4. The optical element according to Claim 3, wherein the plurality of unit patterns includes a first unit pattern and a second unit pattern adjacent to the first unit pattern and the first and second unit patterns are arranged in a different arrangement angle each other in the plane direction.

5. The optical element according to Claim 1, further comprising a covering layer between the grid and the diffraction function layer, wherein the covering layer is made of a dielectric material.

6. The optical element according to Claim 1, further comprising an antireflection film on the diffraction function layer.

7. A liquid crystal device comprising the optical element according to Claim 1.

8. The liquid crystal device according to Claim 7, further comprising a liquid crystal layer between a pair of substrates, wherein the optical element is formed at a side adjacent to the liquid crystal layer of at least one of the pair of substrates.

9. The liquid crystal device according to Claim 7, wherein the liquid crystal device is a semi-transmissive reflective liquid crystal device in which both a transmissive display and a reflective display are possible in a single pixel, and includes the optical element.

10. An electronic apparatus, comprising the liquid crystal device according to Claim 7.

11. An electronic apparatus, comprising the optical element according to Claim 1.
